(19) United States
(12) Patent Application Publication
(10) Pub. No.: US 2026/0236568 A1
(43) Pub. Date: Aug. 13, 2026

(54) SYSTEMS AND METHODS FOR MULTI-FACTOR AUTHENTICATION USING MULTIMODAL LARGE LANGUAGE MODEL

(71) Applicant: The Toronto-Dominion Bank, Toronto (CA)

(72) Inventors: Mohsen RAZA, Toronto (CA); Shahriar TAHERI, Newmarket (CA)

(73) Assignee: The Toronto-Dominion Bank, Toronto (CA)

(21) Appl. No.: 19/052,730

(22) Filed: Feb. 13, 2025

(51) Int. Cl. G06F 21/32

(52) U.S. Cl. CPC G06F 21/32

(57) ABSTRACT

The present application relates to voice authentication, and more particularly, to systems and methods for voice authentication of commands. The system comprises a communications module; at least one processor coupled to the communications module; and a memory coupled to the at least one processor. The processor-executable instructions configure the at least one processor to: receive, from a remote computing device and via the communications module, voice data; analyze the voice data to identify a command and at least one parameter associated with the command; authenticate the remote computing device at least by conducting voice authentication on the voice data; and responsive to authenticating the remote computing device, signaling the remote computing device via the communications module to enable at least one module on the remote computing device based at least on the command.

### TECHNICAL FIELD

The present application relates to multi-factor authentication, and more particularly, to systems and methods for authentication comprising voice authentication of commands.

### BACKGROUND

Voice authentication is a biometric technology that verifies an identity based on unique vocal characteristics. Voice authentication uses the distinct features of a voice, such as pitch, tone, and speech patterns, to create a voiceprint that can be used for authentication. The process typically involves speaking a specific phrase or sentence, which the system then analyzes and compares to the stored voiceprint.

### BRIEF DESCRIPTION OF THE DRAWINGS

Embodiments are described in detail below, with reference to the following drawings:

FIG. 1 is a schematic operation diagram illustrating an operating environment;

FIG. 2 is a logical block diagram of a remote computing device;

FIG. 3 is a high-level operation diagram of a resource server;

FIG. 4 is a high-level software architecture executing on a computing device;

FIG. 5 is a high-level schematic diagram on a parallel processing architecture;

FIG. 6 is a block diagram of a training system for the parallel processing architecture;

FIG. 7 is a flowchart showing an enrollment process for an authentication model;

FIG. 8 is a flowchart showing an authentication process using the authentication model;

FIG. 9 is a flowchart showing a combined authentication process and a command identification process;

FIG. 10 is a flowchart showing an example command process; and

FIG. 11 is a flowchart showing the authentication process according to another aspect.

Like reference numerals are used in the drawings to denote like elements and features.

### DETAILED DESCRIPTION

According to an aspect, there is provided a server comprising: a communications module; at least one processor coupled to the communications module; and a memory coupled to the at least one processor. The memory may store a plurality of processor-executable instructions which, when executed, configure the at least one processor to: receive, from a remote computing device and via the communications module, voice data; analyze the voice data to identify a command and at least one parameter associated with the command; authenticate the remote computing device at least by conducting voice authentication on the voice data; and responsive to successfully authenticating the remote computing device, signaling the remote computing device via the communications module to enable at least one module on the remote computing device based at least on the command.

When conducting the voice authentication on the voice data, the processor-executable instructions, when executed, further configure the at least one processor to: extract at least one feature from the voice data to produce a current voiceprint; retrieve a voiceprint from a voiceprint database; generate a similarity score between the current voiceprint and the voiceprint; and determine that the similarity score is above a threshold to complete the voice authentication. When generating the similarity score, the processor-executable instructions, when executed, further configure the at least one processor to: engage an artificial intelligence engine to generate the similarity score based at least on the voice data and the voiceprint. The processor-executable instructions may further configure the processor to: determine that the similarity score is below the threshold; and in response to the determining that the similarity score is below the threshold, initiate an alternative authentication method.

When analyzing the voice data, the processor-executable instructions, when executed, may further configure the at least one processor to: engage an artificial intelligence engine transforming the voice data into at least one embedding; compare the at least one embedding with a plurality of command embeddings to identify the command; and compare the at least one embedding with a plurality of parameter embeddings to identify the at least one parameter.

When enabling the at least one module on the remote computing device, the processor-executable instructions, when executed, may further configure the at least one processor to: cause the remote computing device to indicate by way of a selectable element that the at least one module is enabled.

When enabling the at least one module of the remote computing device, the processor-executable instructions, when executed, further configure the at least one processor to: cause the remote computing device to execute an image capture module to capture image data; receive, via the communications module and from the remote computing device, the image data; and initiate a data transfer at least based on analyzing the image data.

When signalling the remote computing device, the processor-executable instructions, when executed, may further configure the at least one processor to: send a push notification to the remote computing device with a payload causing the at least one module to be enabled. When signalling the remote computing device, the processor-executable instructions, when executed, may further configure the at least one processor to: send an application programming interface request to the remote computing device to cause the at least one module to be enabled.

When enabling the at least one module of the remote computing device, the processor-executable instructions, when executed, further configure the at least one processor to: enable an image capture module of the remote computing device to capture image data. The processor-executable instructions, when executed, further configure the at least one processor to: identify a secure-logical storage associated with the at least one parameter; receive, via the communications module and from the remote computing device, the image data; analyze the image data to identify at least a second secure-logical storage for a transfer; and initiate a data transfer from the second secure-logical storage to the secure-logical storage. The processor-executable instructions may further configure the processor to: identify the secure-logical storage based at least on the at least one parameter.

According to another aspect, there is provided a computer-implemented method comprising: receiving, from a remote computing device and via a communications module, voice data; analyzing the voice data to identify a command and at least one parameter associated with the command; identifying a secure-logical storage associated with the at least one parameter; authenticating the remote computing device at least by conducting voice authentication on the voice data; and responsive to successfully authenticating the remote computing device, signaling the remote computing device via the communications module to enable at least one module on the remote computing device. The voice authentication may comprise: extracting at least one feature from the voice data to produce a current voiceprint; retrieving a voiceprint; and comparing the voice data and the voiceprint. The voice authentication may further comprise: generating a similarity score between the voice data and the voiceprint; and determining that the similarity score is above a threshold to complete the voice authentication. The generating of the similarity score may comprise: engaging an artificial intelligence engine to generate the similarity score based at least one the voice data and the voiceprint. The computer-implemented method may further comprise: determining that the similarity score is below the threshold; and in response to determining that the similarity score is below the threshold, initiating an alternative authentication method.

The computer-implemented method may further comprise: engaging an artificial intelligence engine transforming the voice data into at least one embedding; comparing the at least one embedding with a plurality of command embeddings to identify the command; and comparing the at least one embedding with a plurality of parameter embeddings to identify the at least one parameter.

When enabling the at least one module on the remote computing device, the computer-implemented method may further comprise: causing the remote computing device to indicate on a selectable element that the at least one module is enabled.

When the command corresponds to depositing a value instrument, the method further comprises: causing the remote computing device to execute an image capture module to capture image data. The computer-implemented method may further comprise: receiving, via the communications module and from the remote computing device, the image data; analyzing the image data to identify at least a second secure-logical storage for a transfer; and initiating a data transfer from the second secure-logical storage to the secure-logical storage.

When signalling the remote computing device, the computer-implemented method further comprises at least one of: sending a push notification to the remote computing device with a payload causing the at least one module to be enabled; and sending an application programming interface request to the remote computing device to cause the at least one module to be enabled

According to yet another aspect, there is provided a non-transitory computer readable storage medium comprising processor-executable instructions which, when executed, configure at least one processor to: receive, from a remote computing device and via a communications module, voice data; analyze the voice data to identify a command and at least one parameter associated with the command; identify a secure-logical storage associated with the at least one parameter; authenticate the remote computing device at least by conducting voice authentication on the voice data; and responsive to authenticating the remote computing device, signaling the remote computing device via the communications module to enable at least one module on the remote computing device.

Other aspects and features of the present application will be understood by those of ordinary skill in the art from a review of the following description of examples in conjunction with the accompanying figures.

In the present application, the term “and/or” is intended to cover all possible combinations and sub-combinations of the listed elements, including any one of the listed elements alone, any sub-combination, and/or all the elements, and may include additional elements.

In the present application, the phrase “at least one of ...or...” is intended to cover any one or more of the listed elements, including any one of the listed elements alone, any sub-combination, or all the elements, and may include any additional elements, and may not require all the elements.

In the present application, examples involving a general-purpose computer, aspects of the disclosure transform the general-purpose computer into a special-purpose computing device when configured to execute the instructions described herein.

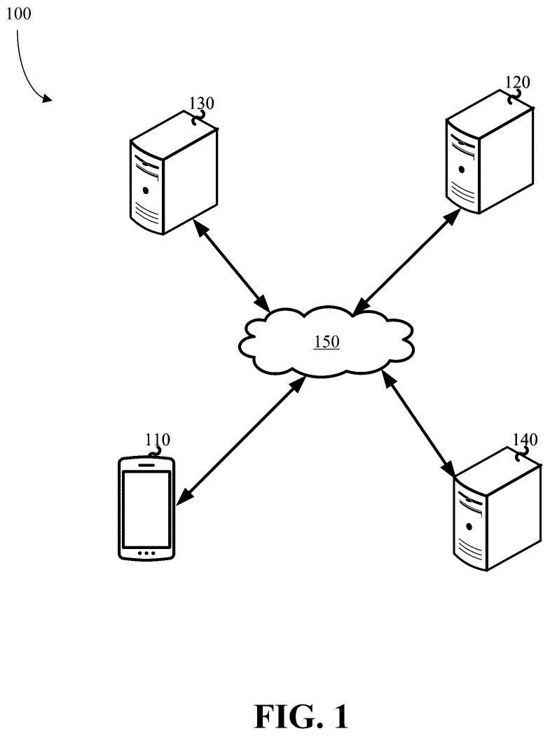

FIG. 1 is a schematic operation diagram illustrating an operating environment. As shown, a networked computing system 100 may include a remote computing device 110, a central counterparty server 120, a parallel computing server 140, and a resource server 130 coupled to one another through a network 150, which may include a public network such as the Internet and/or a private network. The remote computing device 110 may be referred to as a mobile computing device and may be associated with a secure-logical storage associated with the resource server 130. The remote computing device 110, the central counterparty server 120, the parallel computing server 140, and the resource server 130 may be in geographically disparate locations. Put differently, the remote computing device 110, the central counterparty server 120, the parallel computing server 140, and the resource server 130 may be located remote from one another. In other aspects, the parallel computing server 140 and the resource server 130 may be located at the same location.

The resource server 130 may be referred to as an access control server and may be configured to control access to protected data stored within a plurality of secure-logical storages. The resource server 130 may maintain a protected data resource storing database records for a plurality of entities. In at least some aspects, the resource server 130 may be provided by a financial institution which may maintain customer bank accounts. The protected data resource that may be logically separated into one or more secure-logical storages associated with one or more entities. The secure-logical storages may store a data record that may, for example, reflect an amount of value stored in that secure-logical storage associated with the entity. The resource server 130 may protect the secure-logical storages using bank-grade security. The resource server 130 and/or the central counterparty server 120 may be connected over the network 150 via a virtual private network and/or a bank-grade encryption protocol.

While FIG. 1 illustrates the central counterparty server 120, the parallel computing server 140, and the resource server 130 as single servers, more than one such server may be engaged and connected through the network 150. Further, the resource server 130 may be connected to one or more data resources such as, for example, a computer system that includes one or more database servers, computer servers, and the like. The protected data resource and/or the central counterparty server 120 may provide, for example, an application programming interface (API) for a web-based system, operating system, database system, computer hardware, and/or software library.

The system 100 includes at least one of the application servers executing on the resource server 130. The application server may be associated with an application 410 (such as a web or mobile application) that is resident on the remote computing device 110. The application 410 may retrieve and/or instruct the application server via an application programming interface (API). For example, the application server may connect the remote computing device 110 to a back-end system associated with the application 410. The application server may be configured to perform, among others, user management, data storage, security, transaction processing, resource pooling, push notifications, messaging, and/or off-line support of the application 410. The application server may be connected to the remote computing device 110, the central counterparty server 120, and/or the parallel computing server 140 via the network 150.

The network 150 is a computer network. In some aspects, the network 150 may be an internetwork such as may be formed of one or more interconnected computer networks. For example, the network 150 may be or may include an Ethernet network, an asynchronous transfer mode (ATM) network, a wireless network, a telecommunications network, a satellite network, or the like.

The remote computing device 110, the central counterparty server 120, the resource server 130, and the parallel computing server 140 are computer systems. The remote computing device 110 may take a variety of forms including, for example, a mobile communication device such as a smartphone, a tablet computer, a wearable computer such as a head-mounted display or smartwatch, a laptop or desktop computer, or a computing device of another type. In some aspects, the entity may operate the remote computing device 110 to cause the remote computing device 110 to perform one or more operations as described herein.

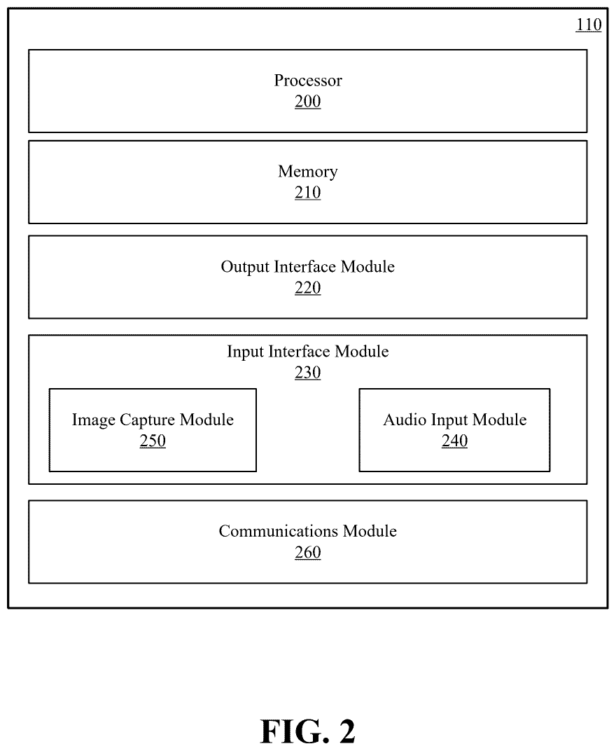

FIG. 2 illustrates components of the remote computing device 110. The remote computing device 110 includes a variety of modules. For example, as illustrated, the remote computing device 110, may include a processor 200, a computer-readable memory 210 (also known as a non-transitory computer readable storage medium), an output interface module 220, an input interface module 230, an audio input module 240, an image capture module 250, and/or a communications module 260. The foregoing example modules of the remote computing device 110 may be in communication over a bus.

The processor 200 is a hardware processor. The processor 200 may, for example, be one or more ARM, Intel x86, PowerPC processors or the like.

The computer-readable memory 210 allows data and/or instructions to be stored and retrieved. The computer-readable memory 210 may include, for example, random access memory, read-only memory, and persistent storage. Persistent storage may include, for example, flash memory, a solid-state drive or the like. Read-only memory and persistent storage are a computer-readable medium. A computer-readable medium may be organized using a file system such as may be administered by an operating system 420 governing overall operation of the remote computing device 110. The computer-readable memory 210 may comprise a storage module for storing and retrieving data. Additionally or alternatively, the storage module may be used to store and retrieve data from persisted storage that may not be accessible via the computer-readable memory 210. In some aspects, the storage module may be used to store and retrieve data in a database. A database may be stored in persisted storage. Additionally or alternatively, the storage module may access data stored remotely such as, for example, as may be accessed using a local area network (LAN), wide area network (WAN), personal area network (PAN), and/or a storage area network (SAN). In some aspects, the storage module may access data stored remotely using the communications module 360. In some aspects, the storage module may be omitted, and its function may be performed by the computer-readable memory 210 and/or by the processor 200 in concert with the communications module 260 such as, for example, when data is stored remotely. The storage module may also be referred to as a data store.

The input interface module 230 allows the remote computing device 110 to receive input signals. Input signals may, for example, correspond to input received from a user. The input interface module 230 may serve to interconnect the remote computing device 110 with one or more input devices. Input signals may be received from input devices by the input interface module 230. Input devices may, for example, include one or more of a touchscreen input, keyboard, trackball, voice command interface, or the like. In some aspects, all or a portion of the input interface module 230 may be integrated with an input device. For example, the input interface module 230 may be integrated with one of the input devices. The input interface module 230 may include an input device allowing input to be provided to the remote computing device 110. Input received via the input interface module 230 may be conveyed to the processor 200. The input interface module 230 may be used by the entity to provide a personal identification number (PIN) to the remote computing device 110 as a part of authenticating a resource management application 412 executing on the remote computing device 110 with an authentication server executing on the resource server 130 as described in further detail herein.

In some aspects, the input interface module 230 may comprise one or more image capture modules 250 and/or one or more sensor modules. The image capture module 250 may be or may include a camera. The image capture module 250 may be used to obtain image data, such as images. The image capture module 250 may be or may include a digital image sensor system as, for example, a charge coupled device (CCD) or a complementary metal-oxide-semiconductor (CMOS) image sensor. The sensor module may include a sensor that generates sensor data based on a sensed condition. By way of example, the sensor module may be or include a location subsystem which generates location data indicating a location of the remote computing device 110. The location may be the current geographic location of the remote computing device 110. The location subsystem may be or include any one or more of a global positioning system (GPS), an inertial navigation system (INS), a wireless (e.g., cellular) triangulation system, a beacon-based location system (such as a Bluetooth low energy beacon system), or a location subsystem of another type.

In one or more aspects, the image capture module 250 may be adapted to scan or capture image data of one or more value instruments. For example, the image capture module 250 may scan and/or capture image data of value instruments (such as, for example, bank notes, negotiable instruments like cheques, money orders, bank drafts, warrants of payment, redemption codes, titles, deeds, etc.). In some aspects, the value instruments may be represented by one or more quick response (QR) codes. The image capture module 250 may be configured to capture image data in colour, black and white, grayscale, and/or any multispectral light. In one or more aspects, image capture module 250 may include an ultraviolet image sensor and/or an infrared image sensor to capture image data of one or more security features for counterfeit detection. The remote computing device 110 may send the image data of the value instrument to the resource server 130. The resource server 130 may process the image data as described in further detail below.

In one or more aspects, the input interface module 230 may comprise an audio input module 240 for recording voice data. Voice data may include voice signals and potentially background noise. It may be appreciated that the voice data may be preprocessed to reduce and/or eliminate noise and/or increase the voice signals. The preprocessing may be performed at least partially by the remote computing device 110. The audio input module 240 may comprise one or more microphones. The techniques described herein are not limited to the type of microphone technology and may be applicable to dynamic microphones, condenser microphones, ribbon microphones, carbon microphones, and/or crystal microphones. The microphones may include omnidirectional, cardioid, figure-8, and/or multi-pattern.

The audio input module 240 may be sensitive between 30-Hz to 20-kHz. In some aspects, the audio input module 240 may be particularly sensitive for human voice, such as in the range of 85-Hz to 255-Hz, or in a broader range of 80-Hz to 1100-Hz. The audio input module 240 may comprise one or more filters to filter an audio signal to these frequency ranges. The filters may include physical filters and/or digital filters. The filters may include high-pass filters to remove low-frequency noise, low-pass filters to remove high-frequency noise, notch filters to remove unwanted sounds, band-pass filters to isolate human voice, noise gate filters to remove audio below a threshold, de-Esser filters to remove harsh “s” sounds, and/or equalizer filters to enhance specific frequency ranges to improve speech intelligibility. In some aspects, multiple microphones may be used to reduce and/or eliminate background noise within the voice data by subtracting the background noise from the voice data. In some aspects, the filters may process the voice data that includes human voices.

The output interface module 220 allows the remote computing device 110 to provide output signals. Some output signals may, for example, allow provision of output to a user. The output interface module 220 may serve to interconnect the remote computing device 110 with one or more output devices. Output signals may be sent to output devices by an output interface module 220. Output devices may include, for example, a display screen such as, for example, a liquid crystal display (LCD), a touchscreen display. Additionally, or alternatively, output devices may include other output devices such as, for example, a speaker, indicator lamps (such as for example light-emitting diodes (LEDs)), and printers. In some aspects, all or a portion of the output interface module 220 may be integrated with an output device. For example, the output interface module 220 may be integrated with one of the output devices.

The communications module 260 allows the remote computing device 110 to communicate with other electronic devices and/or various communications networks. For example, the communications module 260 may allow the remote computing device 110 to send or receive communications signals. Communications signals may be sent and/or received according to one or more protocols or according to one or more standards. For example, the communications module 260 may allow the remote computing device 110 to communicate via a cellular data network, such as for example, according to one or more standards such as, for example, Global System for Mobile Communications (GSM), Code Division Multiple Access (CDMA), Evolution Data Optimized (EVDO), Long-term Evolution (LTE) or the like. The communications module 260 may allow the remote computing device 110 to communicate using near-field communication (NFC), via Wi-Fi™, using Bluetooth™ or via some combination of one or more networks or protocols. In some aspects, all or a portion of the communications module 260 may be integrated into a component of the remote computing device 110. For example, the communications module 260 may be integrated into a communications chipset.

Software comprising a plurality of instructions is executed by the processor 200 from a computer-readable medium. For example, software may be loaded into random-access memory from persistent storage of computer-readable memory 210. Additionally, or alternatively, instructions may be executed by the processor 200 directly from read-only memory of computer-Readable memory 210.

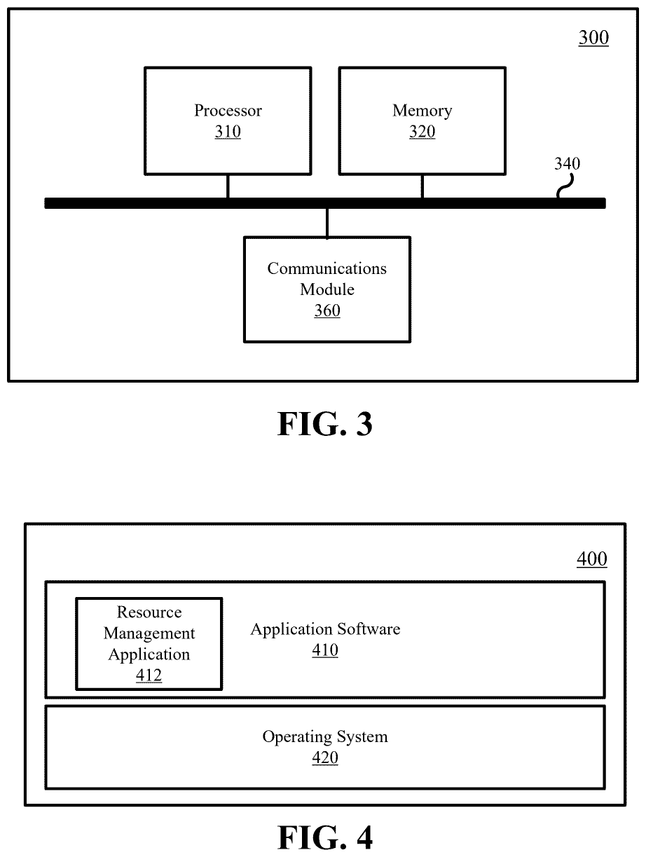

Turning to FIG. 3, the central counterparty server 120 and the resource server 130 are computer server systems 300. A computer server system may, for example, be a mainframe computer, a minicomputer, or the like. In some implementations thereof, a computer server system may be formed of or may include one or more computing devices. A computer server system may include and/or may communicate with multiple computing devices such as, for example, database servers, computer servers, and the like. Multiple computing devices such as these may be in communication using a computer network and may communicate to act in cooperation as a computer server system. For example, such computing devices may communicate using a local-area network (LAN). In some embodiments, a computer server system may include multiple computing devices organized in a tiered arrangement. For example, a computer server system may include middle tier and back-end computing devices. In some aspects, a computer server system may include a cluster formed of a plurality of interoperating computing devices.

The computer server system 300 may comprise a variety of modules. For example, as illustrated, the computer server system 300 may include a processor 310, a computer-readable memory 320, and a communications module 360. These modules may communicate over a bus 340.

The processor 310 may include a hardware processor. The processor 310 may, for example, be one or more ARM, Intel x86, PowerPC processors or the like. The processor 310 may include a single-core or a multi-core processor. The processor 310 may have one or more interfaces, such as buses, ports, etc., for communicating with other hardware devices that are not illustrated to simplify the figure.

The computer-readable memory 320 allows data and/or instructions to be stored and retrieved. The computer-readable memory 320 may include, for example, random access memory, read-only memory, and persistent storage. Persistent storage may include, for example, flash memory, a solid-state drive or the like. Read-only memory and persistent storage are non-transitory computer-readable storage mediums. A computer-readable medium may be organized using a file system such as may be administered by an operating system 420 governing overall operation of the computer server system 300.

The communications module 360 allows the computer server system 300 to communicate over the network 150 to send and receive data.

FIG. 4 depicts a simplified organization of software components 400 stored in the computer-readable memory 320 of the computer server system 300 or the computer-readable memory 210 of the remote computing device 110. As illustrated these software components include an operating system 420 and an application 410. The operating system 420 is software. The operating system 420 allows the application 410 to access the processor 310, the computer-readable memory 320, and/or the communications module 360. The operating system 420 may include, for example, Apple's iOS™, Google's Android™, Linux™, Unix™, Microsoft's Windows™, Apple OSX™, or the like.

The application 410 adapts the computer server system 300 or the remote computing device 110, in combination with the operating system 420, to operate as a device performing functions as described herein. For example, the application 410 may cooperate with the operating system 420 to adapt a suitable aspect of the computer server system 300 to operate as the resource server 130, and/or the central counterparty server 120. In some aspects, the application 410 may provide an application server for interfacing with an application 410 that is executing on the remote computing device 110. In another example, the application 410 may cooperate with the operating system 420 to adapt a suitable aspect of the remote computing device 110 to operate as the resource management application 412. The resource management application 412 may receive data and/or provide commands to the resource management server executing on the resource server 130.

While an application 410 is illustrated in FIG. 3 as a single application, in operation, the computer-readable memory 210 and/or the computer-readable memory 320 may include more than one application 410, and the applications 410 may perform different operations. For example, in aspects where the application 410 is functioning as the resource management application on the remote computing device 110, the application 410 may be configured for secure communications with the resource server 130 and/or the central counterparty server 120 and may provide various banking functions such as, for example, display of account balances, transfers of value (e.g. bill payments, money transfers), and other resource management functions.

The on-device application data may include one or more of a list of applications installed on the remote computing device 110, levels of permission granted to the installed applications, internet search history data, and/or activity data indicating activity performed on the remote computing device 110.

By way of further example, in at least some aspects in which the application 410 executes on the remote computing device 110, the applications 410 may include a web browser, which may also be referred to as an Internet browser. In at least some such embodiments, the resource server 130 may execute an application server providing a web server that may serve one or more of the interfaces described herein. The web server may cooperate with the web browser and may serve an interface when the interface is requested through the web browser. For example, the web server may serve as a mobile banking interface.

By way of further example, in at least some aspects in which the application 410 executes on the remote computing device 110, the application 410 may include an electronic messaging application. The electronic messaging application may be configured to display a received electronic message such as an email message, short messaging service (SMS) message, or a message of another type.

The resource server 130 may be associated with a financial institution and the financial institution may be the same financial institution associated with the remote computing device 110. The resource server 130 and the remote computing device 110 may perform operations to provide services to the financial institution. The resource server 130 may perform operations related to performing transactions using the remote computing device 110. For example, the resource server 130 may perform operations related to authorizing and/or completing transactions based on cheques deposited by the remote computing device 110. The resource server 130 may additionally or alternatively perform operations related to authenticating an entity of the remote computing device 110. For example, the resource server 130 may perform operations to authenticate an entity based on data from a card and based on a personal identification number (PIN) received as input by the remote computing device 110. As will be described in more detail below, the services may include receiving image data of value instruments captured by the remote computing device 110.

The resource server 130 may operate in conjunction with a protected data resource that stores secure data. In particular, the protected data resource may include one or more secure-logical storage locations that may store records for accounts that are associated with various entities. That is, the secure data may comprise account data for one or more specific entities. For example, an entity that operates the remote computing device 110 may be associated with an account having one or more records in the protected data resource. In at least some aspects, the records may reflect a quantity of stored resources that are associated with the entity. Such resources may include owned resources and/or borrowed resources (e.g. resources available on credit). The quantity of resources that are available to or associated with a secure-logical storage holder may be reflected by a balance defined in an associated record.

For example, the secure data in the protected data resource may include financial data, such as banking data (e.g. bank balance, historical transactions data, etc.) and investment data (e.g. portfolio information) for the entity. In particular, the resource server 130 may include a financial institution (e.g. bank) server and the secure-logical storage holder may be linked to a record of an account of the financial institution which operates the financial institution server. The financial data may, in some aspects, include processed or computed data such as, for example, an average balance associated with an account, an average spending amount associated with an account, a total spending amount over a period, or other data obtained by a processing server based on account data for the entity.

In some aspects, the protected data resource may include a computer system that includes one or more database servers, computer servers, and the like. In some embodiments, the protected data resource may comprise an application programming interface (API) for a web-based system, operating system, database system, computer hardware, or software library.

The central counterparty server 120 may be adapted to be an electronic clearinghouse for receiving image data of the value instruments. In some aspects, the remote computing device 110 may transmit the image data directly to the central counterparty server 120. In some aspects, the remote computing device 110 may transmit the image data to the resource server 130, which may subsequently transmit the image data to the central counterparty server 120. In some aspects, the resource server 130 may process the image data as described in further detail herein and transmit one or more results of the processing to the central counterparty server 120.

In general, the resource server 130 receives the image data and processes the image data to determine an amount of resource to be deposited to a first secure digital storage associated with the remote computing device 110. The resource server 130 may transfer the amount of resource into the first secure digital storage. The resource server 130 may provide the image data of the value instrument to the central counterparty server 120. The central counterparty server 120 may identify a second resource server (not shown) associated with the value instrument based on the image data. The central counterparty server 120 may route the image data to the second resource server. The second resource server may determine a second secure digital storage associated with the value instrument based on the image data. The second resource server may transfer the amount of the resource out of the second secure digital storage.

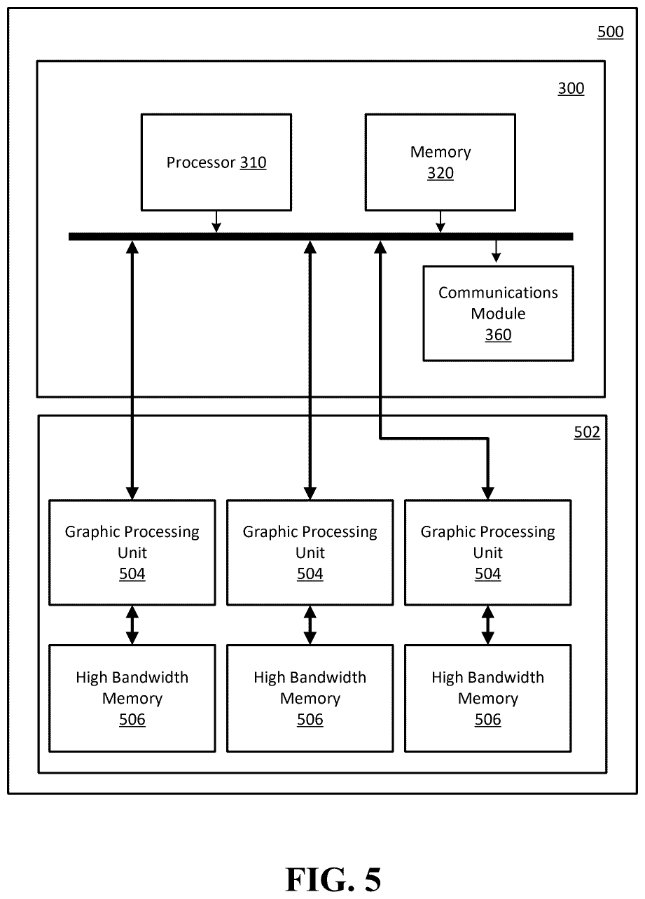

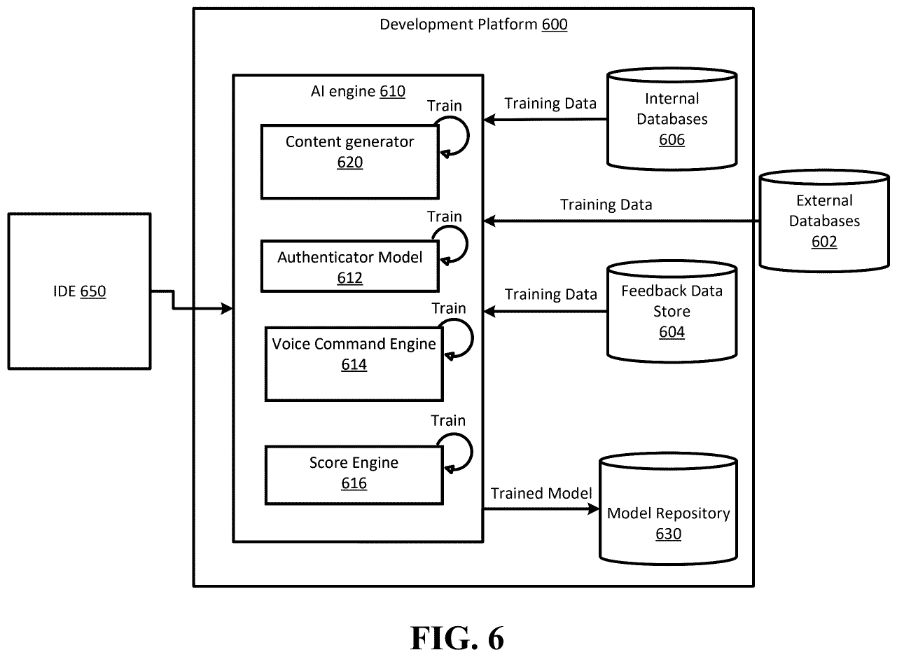

Turning to FIGS. 5 and 6, the parallel computing server 140 comprises a processing structure 500. The processing structure 500 may comprise a computer server system 300 as previously described with reference to FIG. 3. In some aspects, the computer server system 300 may be the same as the resource server 130 in that the computer server system 300 comprises the processor 310, the computer-readable memory 320, and the communications module 360. In other aspects, the computer server system 300 may be a distinct computing server. In any event, the computer server system 300 may manage a parallel computing structure 502. The parallel computing structure 502 may comprise a plurality of graphic processing units (i.e. GPUs 504) having a high-bandwidth memory 506 associated with each of the GPUs 504.

The processor 310 may execute one or more instructions from the computer-readable memory 320 to manage a parallel computing structure 502. The processor 310 may execute a distributing module that may comprise instructions to send, transmit, and/or distribute data to be processed to at least one of the GPUs 504. The distributing module may monitor a workload of the GPUs 504 to select the GPU 504 with available capacity. For example, the GPUs 504 may periodically post workloads to the distributing module (e.g. approximately 15-minute intervals) via an application interface. The distributing module may determine that one of the GPUs 504 has a low workload, or workload below a threshold, and in response, distribute data to be processed to that one of the GPUs 504. In some aspects, the distributing module may cooperate with a priority module to assign to the GPUs 504 a higher or greater priority before lower or lesser priority data transfers.

The parallel computing structure 502 may execute an artificial intelligence engine (i.e. AI engine 610) or more artificial intelligence (AI) engines. In this aspect, the AI engine 610 may comprise one or more replicas of an AI model, such as, but not limited to, a large language model (LLM), a multimodal LLM, a Generative Adversarial Networks (GANs), a Variational Autoencoder (VAE), a Recurrent Neural Network (RNN), a Transformer, a Diffusion Model, and/or any combination thereof executing in series, parallel, and/or recursively. For ease of reference, the replica is generally referred to as the AI engine 610. Each of the replicas may execute on one or more of the GPUs 504. One or more of these AI models may be selected based on the data and/or processing task to be performed as described in further detail herein. The processor 310 may instruct the parallel computing structure 502 to retrieve the selected AI model from a model repository 630 and load the AI model into the high-bandwidth memory 506 for execution by the GPU 504 prior to processing the data. In some aspects, a previously executing AI engine 610 that is no longer being used may be reset in preparation for the new interaction.

Turning to FIG. 6, an AI development platform 600 is shown for training one or more of the AI models (e.g. 612, 614, 616, 620) of the AI engine 610. An integrated development environment (i.e. IDE 650) may enable a provider to develop, train, and/or retrain the AI engine 610. The IDE 650 may include an application 410 with a programming interface accessible by a developer device (not shown), which may be the remote computing device 110, over the network 150 or via a local connection. The IDE 650 may include a web application that can be accessed at a network address, uniform resource locator (URL), etc. The IDE 650 may be locally or remotely installed on the remote computing device 110 where the IDE 650 is accessed and used locally.

The IDE 650 may be used to design an AI engine 610 using the user interface of the IDE 650. For example, the user interface may be output as part of the software application that interacts with the IDE 650. A developer may use an input mechanism to make selections from menus to add pieces to the AI engine 610, such as data components, model components, analysis components, etc., within a workspace of the user interface. The menus may include a plurality of graphical user interface (GUI) menu options, which can be selected to reveal additional components that can be added to the model design shown in the workspace. The GUI menu options may include options for adding features such as neural networks, machine learning models, AI models, data sources, conversion processes (e.g., vectorization, encoding, etc.), analytics, etc. The developer may continue to add features to the AI engine 610 and connect the features using edges and/or other means to create a flow within the workspace. For example, the developer may add a node to a flow of a new model within the workspace. For example, the developer may connect a node to another node in the flow via an edge, creating a dependency within the flow. When the developer is done, the IDE 650 can save the AI engine 610 and/or AI models for subsequent training and/or testing.

The training process for training and/or retraining the AI engine 610 may involve an executable script configured to read data from the data resource 606 and/or the external database 602 and input the data to the AI engine 610. For example, the executable script may use identifiers (IDs) of one or more data locations (e.g., table IDs, row IDs, column IDs, topic IDs, object IDs, etc.) to identify locations of the training data within the data resource 606 and query an API of the data resource 606. In response, the data resource 606 may receive the query, load the requested data, and return the data to the executable script, where the data is input to the AI engine 610. The training process may be managed via an interface of the IDE 650, allowing for supervised learning during the training process. In other aspects, the training process may perform unsupervised learning.

In some aspects, the script may iteratively retrieve additional training data sets from the data resource 606 and iteratively input the additional training data sets into the content generator 620 during the execution to continue to train the AI engine 610. The script may continue until instructions within the script direct the script to terminate, which may be based on iterations (e.g. training loops), total time elapsed during the training process, etc.

The IDE 650 may also be used to retrain the AI engine 610 after being deployed. The training process may use executional results that have been generated or output by the content generator 620, the authenticator model 612, and/or the voice command engine 614 in a live environment for retraining. For example, a score engine 616 may score output from the content generator 620, the authenticator model 612, and/or the voice command engine 614 and feedback those scores to retrain the content generator 620, the authenticator model 612, and/or the voice command engine 614 to further enhance accuracy and/or relevancy. The feedback may include indications of whether the generated output scores match or exceed scores resulting from a manual evaluation, such as based on the feedback received from the entity. In yet another example, the feedback from the entity may be used to train and/or retrain the content generator 620, the authenticator model 612, and/or the voice command engine 614 to further enhance its accuracy, relevancy, and/or reliability. The feedback data may be captured and stored within a feedback data store 604 or other data store within the live environment and can be subsequently used to retrain the score engine 616 and/or the content generator 620, the authenticator model 612, and/or the voice command engine 614.

The AI engine 610 may comprise a content generator 620, an authentication model 612, a voice command engine 614, and/or a score engine 616.

The content generator 620 may include a multimodal large language model (LLM) trained to provide one or more artificially generated audio responses to the entity. To generate the artificially generated audio response, the content generator 620 may be trained on historical conversation content. The content generator 620 may be trained from historical conversation content from an external database 602 and/or data resource 606. In some aspects, the content generator 620 may be configured to retrieve profile data from a secure-logical storage area associated with the entity. In some aspects, the historical conversation content may include historical conversations with the entity. The profile data may include account information such as financial account information, health information, transaction history, etc.

In some aspects, the content generator 620 may directly receive audio queries over the network 150 from the entity using the audio input module 240 of the remote computing device 110. In response to the audio queries, the content generator 620 may generate an audio response. In this aspect the content generator 620 may comprise an audio-LLM.

In other aspects, the content generator 620 may operate in conjunction with a speech-to-text engine (such as an automatic speech recognition (ASR) and/or natural language processing (NLP)) that transforms the audio queries into textual queries and the content generator 620 may directly generate an audio response. In yet other aspects, the content generator 620 may operate in conjunction with the speech-to-text engine that transforms the audio queries into textual queries and the content generator 620 may generate a textual response. The content generator 620 may operate in conjunction with a text-to-speech engine to transform the textual response into an audio response. The speech-to-text engine may process the audio queries by filtering the audio signal, performing feature extraction, performing acoustic modelling, performing language modelling, and/or decoding. In some aspects, a translation engine may perform translation from one language into another language and vice versa.

In any event, the audio response may be transmitted from the AI engine 610 over the network 150 to the remote computing device 110. The remote computing device 110 may play the audio response via the output interface module 220, such as a speaker and/or headphones. In some aspects, the textual response may be transmitted from the AI engine 610 over the network 150 to the remote computing device 110 and the remote computing device 110 may perform the text-to-speech conversion to convert the textual response into the audio response.

The authentication model 612 may comprise one or more audio pre-processors, one or more feature extraction processes, one or more training processes, and one or more AI models. The AI models may include one or more of: a Gaussian mixture model (GMM), a hidden Markov model (HMM), a convolutional neural network (CNN), a recurrent neural network (RNN), a deep neural network (DNN), a support vector machine (SVM), a transformer, and/or an autoencoder. GMMs are probabilistic models that represent the distribution of features in voice samples and may be effective in modeling a variability in voice data. HMMs are statistical models that represent sequences of observed events, such as speech and may be used for modeling temporal dynamics of voice data. CNNs are deep learning models that may capture spatial features in voice data. RNNs process sequential data by maintaining a memory of previous inputs and may be used for temporal dependencies in voice data. DNNs are multi-layered neural networks that may learn complex patterns in voice data. SVMs are supervised learning models that find an optimal hyperplane to separate different classes of voice data. Transformers are advanced neural network architectures that use self-attention mechanisms to process sequential data. Transformers may process long-range dependencies in voice data. Autoencoders are neural networks used for unsupervised learning and may be used for anomaly detection in voice data.

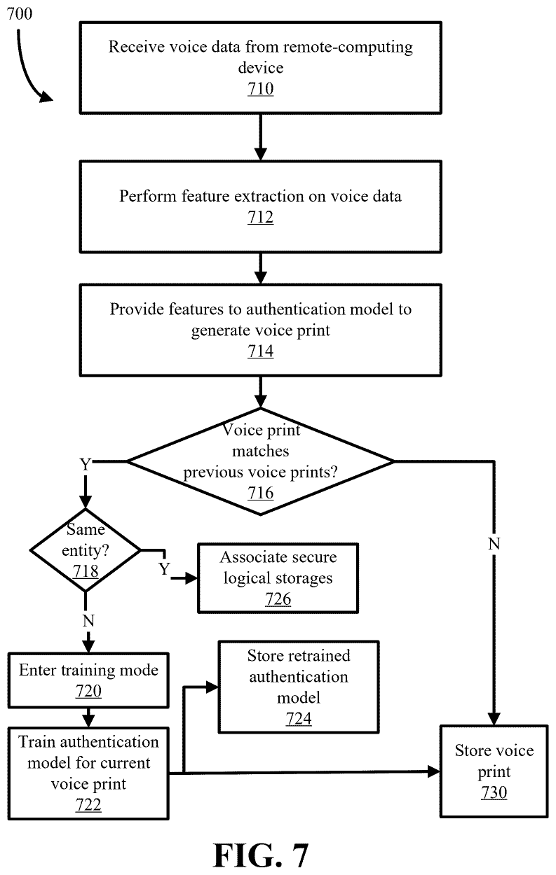

Turning to FIG. 7, the authentication model 612 may be trained for a new entity during an enrollment process 700 whereby the new entity may be asked to recite predetermined phrases and/or talk for a period until the authentication model 612 is able to discriminate between a voice of the current entity and other previous entities. The speech may be captured by the audio input module 240 and the voice data may be transferred from the remote computing device 110 to the communications module 360 via the network 150 to be received by the resource server 130 at step 710. The processor 310 may route the voice data to one of the GPUs 504 executing the authentication model 612.

In some aspects, the voice data may be pre-processed at the remote computing device 110 and/or at the processing structure 500. The pre-processing may involve removing background noise data from the voice signal. In some aspects, the processing structure 500 may comprise an audio processor to extract one or more features from the voice data, such as one or more Mel-frequency cepstral coefficients (MFCCs), pitch, formants, tone, speaking style, vocal timbre, pitch, speech patterns, physiological attributes, etc. The MFCCs may include a representation of a short-term power spectrum of the voice data. The audio processor may include a discrete hardware processor associated with the computer server system 300 or, in other aspects, be a feature extraction process 712 executing on one of the GPUs 504. In some aspects, the feature extraction process 712 may execute on the GPU 504 that is the same as the GPU 504 executing the authentication model 612.

The extracted features may be provided to the authentication model 612 at step 714. The authentication model 612 may have been previously trained on voice data from other entities. In other aspects, the authentication model 612 may have been previously trained on synthetic voice data, such as generated by a text-to-speech engine and/or a large repository of speech data. One step may be to provide the extracted features and/or the voice data from the current entity to the authentication model 612 to generate a current voiceprint. The current voiceprint may comprise embeddings and/or feature vectors. The current voiceprint may be compared to previous voiceprints at step 716. The previous voiceprints may have been generated in the same or similar manner as the current voiceprint.

When the current voiceprint does not match any of the previous voiceprints, the authentication model 612 may store the current voiceprint in a voiceprint database at step 730 and associate the current voiceprint with a secure-logical storage associated with the entity. The matching of the current voiceprint and the previous voiceprints may involve generating a similarity score between the current voiceprint and the previous voiceprints. A similarity score may be generated using one or more metrics, such as, for example, a cosine similarity, to compare the previous voiceprints to the new voiceprint. For example, cosine similarity may provide a numerical value between −1 and 1 where 1 indicates the voiceprint vectors are identical in direction, 0 means the voiceprint vectors are orthogonal (completely dissimilar), and −1 means the voiceprint vectors are diametrically opposed. In some aspects, the range of cosine similarity may be restricted to [0, 1] for voiceprints as the embeddings may be normalized to non-negative values. When the similarity score exceeds a threshold, the current voiceprint and the previous voiceprint are a match.

When the current voiceprint matches one or more of the previous voiceprints, the authentication model 612 may determine the secure-logical storage associated with the previous voiceprint. The authentication model 612 may retrieve identification data for the current entity and identification data for the previous entity from their respective secure-logical storages. The identification data for both entities may be compared to determine if the current entity and the previous entity are, in fact, the same entity at step 718. When the current entity and the previous entity are the same entity, then the authentication model 612 may instruct the processor 310 to associate the secure-logical storages with each other at step 726.

When the current entity and the previous entity are different entities, the authentication model 612 may enter a training mode at step 720. In some aspects, the authentication model 612 may freeze one or more initial layers of the pretrained model to retain previously learned features. The freezing of the layers prevents weights of these layers from being updated during the training mode. One or more new layers may be added to the authentication model 612 to adapt the authentication model 612 to the current voiceprint. The new layers may be trained using the extracted features of the current voice data using backpropagation and/or optimization algorithms (e.g. gradient descent) at step 722. In some aspects, the matching previous voiceprints may be used to verify that the current voiceprint is distinct from the previous voiceprints in the retrained authentication model 612 (e.g. that the voiceprint comparison is below the threshold). Once retrained, the authentication model 612 may be stored in the model repository 630 for subsequent voice authentication of entities at step 724. The current voiceprint may be stored in the voiceprint database at step 730.

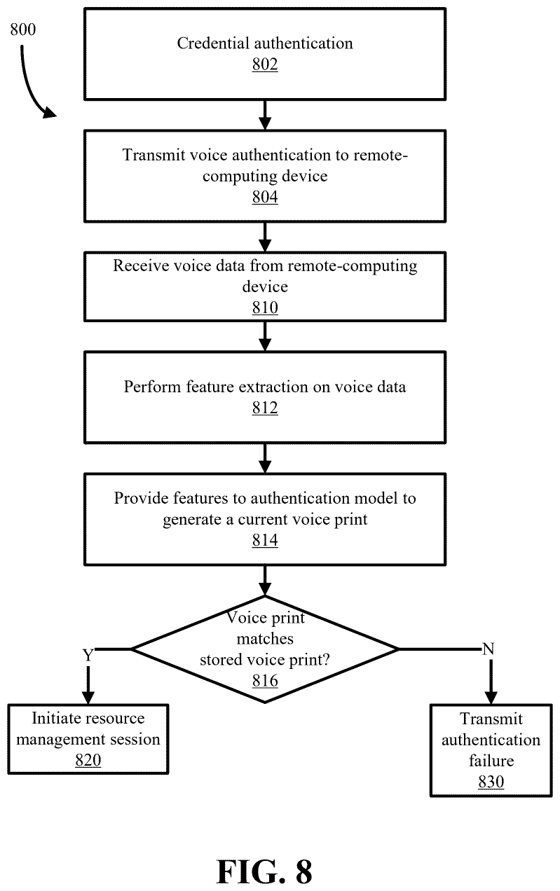

Turning to FIG. 8, an authentication process 800 for authenticating the resource management application 412 executing on the remote computing device 110 with the authentication server executing on the resource server 130 is shown. The authentication process 800 may include a credential authentication 802 whereby the resource management application 412 provides an interface requesting credentials from the entity. The credentials may comprise a username/password and/or biometrics (e.g. facial recognition, fingerprint scan, etc.). The resource management application 412 may transmit the credentials to the resource server 130 over the network 150 via the communications module 260. The resource server 130 may receive the credentials from the network 150 via the communications module 360 and determine if the credentials match the credentials associated with the secure-logical storage. In some aspects, the resource server 130 may perform a two-factor authentication (2FA), such as sending a code (e.g. a one-time password (OTP)) via email and/or short message service (SMS), and/or generated by an authenticator application to be provided to the resource server 130.

In some aspects, the resource server 130 may transmit a voice authentication message to the remote computing device 110 that activates the audio input module 240 at step 804. The resource management application 412, in response to the voice authentication message, may prompt the entity to conduct a voice authentication. The prompt may be an audio prompt, a textual prompt, and/or an image prompt. In some aspects, the voice authentication message may provide one or more authentication phrases that the entity is to recite. In some aspects, the content generator 620 may generate the authentication phrases. In some aspects, the content generator 620 may provide one or more images for display on the remote computing device 110 that the entity is to verbally identify. The resource management application 412 may provide a countdown timer in which the entity may recite the authentication phrases. In other aspects, the resource management application 412 may provide a completion button that the entity may press when recitation of the authentication phrases is complete.

The speech may be captured by the audio input module 240 and the voice data may be transferred from the remote computing device 110 to the communications module 360 via the network 150 where the resource server 130 receives the voice data at step 810. The processor 310 may route the voice data to one of the GPUs 504 executing the authentication model 612 in an authentication mode. In some aspects, the authentication model 612 may be trained to identify features of an automated voiceprint (e.g. a deepfake of the voiceprint) that may be impersonating the voiceprint. When the automated voiceprint is identified by the authentication model 612, the authentication model 612 may lock the secure-logical storage associated with the credentials.

As previously mentioned with reference to FIG. 7, the voice data may be pre-processed at the remote computing device 110 and/or at the processing structure 500 to extract one or more features from the voice data at step 812. The extracted features may be provided to the authentication model 612 at step 814 to generate a current voiceprint. The voiceprint may comprise embeddings and/or feature vectors. The authentication process 800 may retrieve a stored voiceprint associated with the secure-logical storage from the authentication database. The current voiceprint may be compared to the stored voiceprint at step 816. When the current voiceprint does not match any of the stored voiceprints, the authentication model 612 may transmit an authentication failure message to the resource management application 412 and/or terminate a resource management session at step 830. The matching of the current voiceprint and the stored voiceprint may involve generating the similarity score between the current voiceprint and the stored voiceprints. In response to the similarity score exceeding the threshold, the current voiceprint and the stored voiceprint are a match and authentication is confirmed.

In response to the authentication failure message, the resource management application 412 may deauthorize the resource management application 412 from accessing the secure-logical storage. In some aspects, the authentication failure message may initiate an alternative authentication method, such as a 2FA as previously described. If the 2FA fails, the resource management application 412 may deauthorize the resource management application 412 from accessing the secure-logical storage. If the 2FA succeeds, the resource management application 412 may maintain the resource management session.

In response to successfully authenticating the current voiceprint, the resource server 130 may create a resource management session and send a session token to the resource management application 412 at step 820. The resource management application 412 may retrieve data from the secure-logical storage associated with the credentials and display a dashboard or other home screen on the remote computing device 110. In some aspects, the remote computing device 110 may perform one or more resource management tasks associated with the secure-logical storage. The tasks may include depositing funds, withdrawing funds, determining an account balance, etc. In one or more aspects, the remote computing device 110 may perform operations to deposit funds and this may be done in response to the remote computing device 110 receiving one or more cheques. To deposit funds based on one or more cheques, the remote computing device 110 may perform operations for real-time cheque processing.

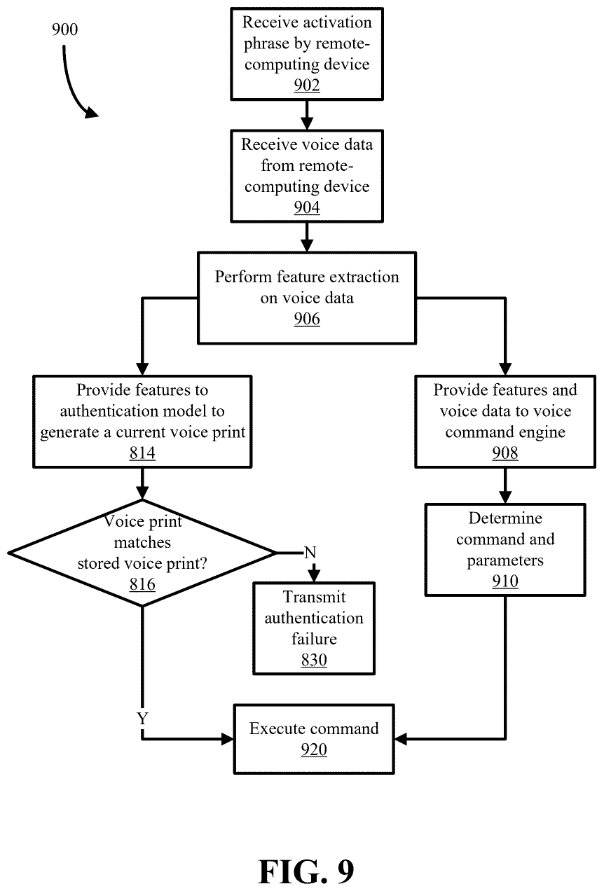

Turning to FIG. 9, a command identification process 900 is shown. In this aspect, the resource management application 412 may be configured to activate when an activation phrase is received by the audio input module 240 at step 902. In response to being activated, the remote computing device may capture voice data from the audio input module 240. The voice data may be transferred to the resource server 130 via the network 150. The resource server 130 may receive the voice data at step 904. As previously mentioned with reference to FIG. 7, the voice data may be pre-processed at the remote computing device 110 and/or at the processing structure 500 to extract one or more features from the voice data at step 906.

As previously described, the extracted features may be provided to the authentication model 612 at step 814 to generate a current voiceprint. The voiceprint may comprise embeddings and/or feature vectors. The stored voiceprint associated with the secure-logical storage may be retrieved from the authentication database. The current voiceprint may be compared to the stored voiceprint at step 816. The matching of the current voiceprint and the stored voiceprint may involve generating the similarity score between the current voiceprint and the stored voiceprints. In response to the similarity score exceeding the threshold, the current voiceprint and the stored voiceprint are a match and authentication is confirmed. When the current voiceprint does not match the stored voiceprint, the authentication model 612 may transmit an authentication failure message to the resource management application 412 at step 830. In some aspects, when the current voiceprint does not match the stored voiceprint, a halt message may be provided to the voice command engine 614 to stop the process of determining the command and/or parameters. In some aspects, when the current voiceprint does not match the stored voiceprint, the execute command at step 920 may be suppressed.

In some aspects, the authentication model 612 may be trained to identify features of an automated voiceprint (e.g. a deepfake of the voiceprint) that may be impersonating the voiceprint. When the automated voiceprint is identified by the authentication model 612, the authentication model 612 may lock the secure-logical storage associated with the credentials.

Simultaneous or nearly simultaneous to the generation of the voiceprint at step 814, the audio features and/or the voice data may be provided to a voice command engine 614 at step 908. In some aspects, the authentication model 612 may execute on a GPU 504 that is different than the GPU 504 executing the voice command engine 614. In other aspects, the authentication model 612 may execute on a GPU 504 that is the same as the GPU 504 executing the voice command engine 614.

The voice command engine 614 may include being previously trained on a plurality of commands to produce a plurality of command embeddings. The plurality of command embeddings may be stored in a command embeddings database. The voice command engine 614 may include being previously trained on a plurality of parameters to produce a plurality of parameter embeddings. The plurality of parameter embeddings may be stored in a parameter embeddings database. In some aspects, the plurality of command embeddings may be generated by a large language model. Likewise, the plurality of parameters may be generated by a large language model. In some aspects, the voice data may be transformed into textual data with a speech-to-text engine prior to being provided to the large language models. In some aspects, the voice command engine 614 may comprise a large language model to determine a command and/or at least one parameter associated with the command based on the textual data. In another aspect, the voice command engine 614 may receive the voice data and may determine the command and/or the at least one parameter within the voice data.

At step 910, the voice command engine 614 may process the voice data into at least one embedding. The at least one embedding may be compared to the plurality of command embeddings and/or the plurality of parameter embeddings. The comparison may generate a score between the at least one embedding and the plurality of command embeddings and/or the plurality of parameter embeddings. Based on the score, the voice command engine 614 may determine one or more of the commands from the plurality of commend embeddings and/or determine one or more parameters from the plurality of parameter embeddings.

In response to the current voiceprint matching the previous voiceprint associated with the secure-logical storage, the resource server 130 may execute the command at step 920. The execution of the command may involve transmitting an activation message to the resource management application 412 and/or executing a command process on the resource server 130 associated with the determined command. In response to the activation message, the resource management application 412 may enable one or more modules.

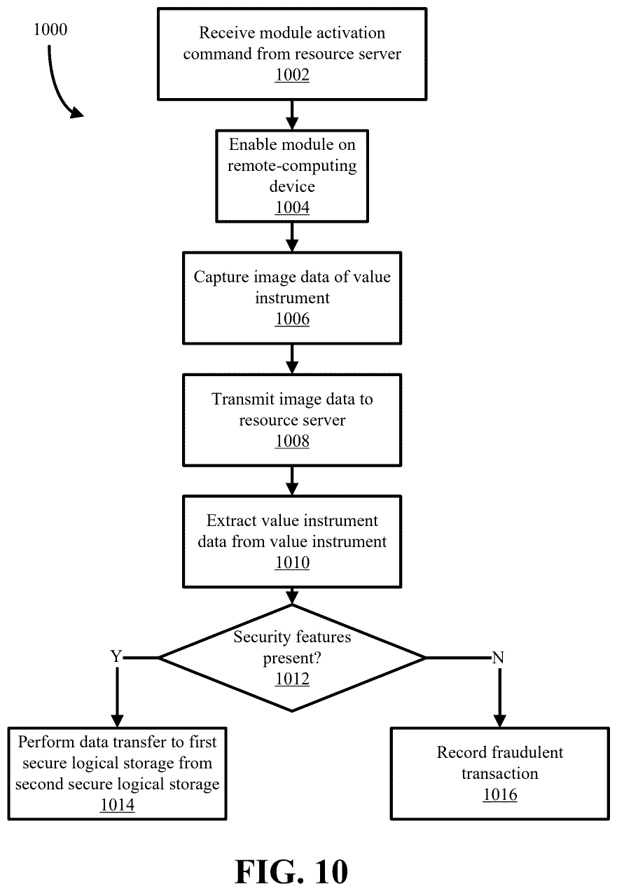

Turning to FIG. 10, there is provided an example of the execute command at step 920. As shown in the figure, a value instrument deposit process 1000 is performed. In this example, the entity may provide a spoken command, such as “I would like to deposit this cheque to my savings account”, captured within the voice data by the audio input module 240. The voice data may be transferred to the resource server 130 and processed by the command identification process 900 as previously described. In response to the command identification process 900, the determined command may be identified as “cheque deposit” and the parameter may be identified as “savings account”. The remote computing device 110 may receive the deposit cheque command (e.g. an activation signal) from the resource server 130 at step 1002.

The activation signalling between the resource server 130 and the remote computing device 110 may be performed in any suitable manner. For example, the resource server 130 may send a signal causing the remote computing device 110 to enable a selectable element of the resource management application 412 for capturing image data. The resource management application 412 may wait for the entity to activate the selectable element whereby the resource management application 412 may capture the image data. The selectable element may be a button, icon, and/or other user interface element and may be labelled “Capture Image” or provide some other indication the selectable element is used to capture images, such as a camera icon. In some aspects, the selectable element may open a camera application on the remote computing device 110.

In another example, the resource server 130 may perform the activation signalling using a full-duplex communication channel, such as WebSockets, between the remote computing device 110 and the resource server 130. In this aspect, the resource server 130 may provide the activation signal via a push notification and in response to the push notification, the remote computing device 110 may enable the selectable element for capturing the image data.

In yet another example, the remote computing device 110 may poll the resource server 130 to retrieve the activation signal and in response to retrieving the activation signal, may enable the capture image module and/or enable the selectable element for capturing the image data.

In yet another example, the resource server 130 may transmit an SMS message to the remote computing device 110 with a payload. The payload may include one or more instructions for the resource management application 412 to enable the selectable element and/or execute the camera application. In some aspects, when the image data is captured, the resource management application 412 may transmit the image data to the resource server 130 by way of a multimedia messaging server (MMS) message.

In another example, the resource server 130 may send an application programming interface request (i.e. an API request) to the remote computing device 110. The API request may trigger a camera event in the resource management application 412 to launch the camera application.

The remote computing device 110 may interpret the activation signal to determine the activation signal is the deposit cheque command. In response to the activation signal, the resource management application 412 may enable a module, such as the image capture module 250, at step 1004. The image capture module 250 may provide an image capture interface on the output interface module 220, such as a display, of the remote computing device 110. In some aspects, the image capture interface may include a separate camera application executed in response to the activation signal. The image capture interface may provide image data from a camera associated with the remote computing device 110. The image data may comprise at least a portion of the value instrument.

In some aspects, to facilitate image capture, the remote computing device 110 may display an image representing a desired capture area together with a viewfinder representing the image data received from the camera. For example, the desired capture area may be displayed on a common page as the viewfinder to allow a user to attempt to use the desired capture area as a model when framing a photo of the value instrument. In some aspects, the image representing the desired capture area may be overlaid on the viewfinder. The overlay may facilitate image capture by allowing the entity to attempt to make live camera data align with the desired capture area. In the overlay, the desired capture area may be displayed as a semi-transparent overlay so as not to block the live camera data.

In enabling image capture, the remote computing device 110 may enable a camera shutter button to allow the camera shutter button to be selected to trigger image capture. That is, until the remote computing device 110 determines that the image data corresponds to the value instrument, the camera shutter button may be disabled and, in response to this determination, the camera shutter button may be enabled. In some aspects, in enabling image capture, the remote computing device 110 may automatically adjust camera settings. For example, the remote computing device 110 may automatically zoom an image and/or may automatically focus.

In other aspects, enabling capture of the image data may include updating the graphical user interface to indicate that image capture is available. For example, when the image data corresponds to the value instrument, the GUI may be updated. By way of example, the output interface module 220 may frame around the viewfinder to indicate the image data corresponds to the value instrument, such as by turning green.

The image capture interface may remain on the output interface module 220 until the image data resembles a value instrument, thereby initiating an automatic capture of the value instrument at step 1006, or until a cancel button is executed by the entity. The value instrument may be determined to be in the image data using one or more image processing steps performed by the remote computing device 110, such as using edge detection to identify one or more boundaries of the value instrument. The image processing steps may involve processing the boundaries using a contour detection process to find a four-sided polygon within the image data. In some aspects, the image data may be analyzed to obtain metadata associated with the value instrument. In one or more aspects, the remote computing device 110 may engage an optical character recognition module to obtain the metadata. The optical character recognition module may analyze the image of the value instrument to obtain the metadata and the metadata may include, for example, drawee such as for example the transit number, institution number and account number of the account from which the funds are to be drawn. The metadata may include value instrument data that identifies the payee's name, the amount and currency of the transaction, a date, account number, etc.

In some aspects, the image data may be transferred to the resource server 130 at step 1008. In this aspect, the resource server 130 may perform the one or more image processing steps, such as using edge detection to identify one or more boundaries of the value instrument. The image processing steps may involve processing the boundaries using a contour detection process to find a four-sided polygon within the image data. In some aspects, the value instrument data may be extracted, such as date, payee name, amount, a second secure-logical storage, a second resource server, etc. using an optical character recognition (OCR) process at step 1010. In another aspect, the image data may be provided to a value instrument engine that has been previously trained to identify the metadata and/or the value instrument data from the image data of the value instrument.

In some aspects, the value instrument engine may have been previously trained to identify one or more security features of the value instruments and/or photographic fraud. The image data may be evaluated to ensure authenticity. For example, photographic fraud could involve an altered photograph (e.g., a photo altered using photo-editing software, such as Photoshop^{TM}), a recycled value instrument (e.g., a value instrument that has already been processed), etc.

When the security features are present at step 1012, the resource server 130 may perform a data transfer to a first secure-logical storage associated with the entity from the second secure-logical storage at step 1014. Step 1014 may involve modifying the data of the first secure-logical storage associated with the entity and stored on the resource server 130. The resource server 130 may transfer the image data and/or the value instrument data to the central counterparty server 120. The central counterparty server 120 may identify the second resource server and the second secure-logical storage and route the image data and/or the value instrument data to the second resource server. The second resource server may modify the amount of data from the second secure-logical storage. In aspects where the resource server 130 and the second resource server are the same resource server, the resource server 130 may bypass transferring the image data and/or the value instrument data to the central counterparty server 120 and may directly modify the amount of data from the second secure-logical storage.

When the security features are not present at step 1012, the resource server 130 may record a potentially fraudulent transaction to have occurred at step 1016. The resource server 130 may provide a potential fraudulent transaction notification to the central counterparty server 120. In response, the central counterparty server 120 may identify similar transactions based on the image data and/or the value instrument data.

In the manners described herein, the resource server 130 may enable image capture only after voice authentication is successfully completed. This reduces the risk of fraud and prevents the transmission and processing of potentially fraudulent value instruments, which would otherwise consume network bandwidth and require downstream mitigation if later detected as fraudulent. By performing voice authentication before enabling the image capture module 250, embodiments described herein ensure that only authorized users can access sensitive functionalities, thereby reducing the risk of unauthorized access or misuse. Computer resource usage efficiency is increased as embodiments described herein prevents unnecessary image processing and storage for unauthorized transactions, freeing up system capacity for legitimate operations. In this way, voice authentication serves as both a trigger and a security layer, enhancing security and efficiency without adding unnecessary manual authentication steps.

Voice authentication may require less computational power than processing image data. By delaying image capture until voice authentication is successful, embodiments described herein avoid unnecessary processing of image data for unauthorized access attempts. Since voice authentication requires less computational power than processing image data, the resource server 130 may allocate computational resources on image capture and processing only when voice authentication is successful. The aspects herein may prevent the resource server 130 from overloading during potentially fraudulent image capture attempts, such as those called by a denial-of-service attack.

By performing voice authentication, the aspects herein may avoid capturing and/or storing image data for unauthorized users, which would unnecessarily consume storage and/or processing power. Voice authentication prior to the image capture may ensure that the image data is only captured for authentic transactions thereby reducing computing resources. The performance of voice authentication may reduce fraudulent image data from being passed on to the central counterparty server 120 thereby reducing network consumption and/or mitigating cascading fraudulent transactions across the clearinghouse process. By limiting the image capture process to authenticated commands, resources are reserved for legitimate cases, reducing overall load on both computational power and storage.

In one or more aspects, responsive to receiving the image data of the value instrument, the resource server 130 and/or the parallel computing structure 502 may perform operations to analyze the image data to ensure that the image data is of sufficient quality. The image data is of sufficient quality may include image data that is not blurry and/or sufficient image data to process the value instrument. In one or more aspects, the resource server 130 may analyze the image to generate metadata and may compare the metadata to that obtained by the remote computing device 110 to ensure that the metadata matches. The resource server 130 may determine that the image data is acceptable and in response the resource server 130 may send a signal that includes an indication of acceptance of the image data to the remote computing device 110.

In embodiments described herein where a LLM is used, the LLM utilizes pre-trained features to quickly analyze voice and image data without needing to process them from scratch. By utilizing natural language processing capabilities, the LLM may streamline voice authentication with minimal computational overhead, avoiding the need for complex, resource-intensive algorithms.

Although a specific example is provided regarding FIG. 10, this specific example is merely an example and one of skill in the art on review of the present application would acknowledge other examples are possible fully within the teachings of the present application.

For example, the enabled module may include enabling a location tracking module of the remote computing device 110. The location tracking module may provide coordinates for the remote computing device 110, such as from a global positioning system. The coordinate may be provided to the resource server 130 to assist in fraud detection. For example, the remote computing device 110 may be restricted to a geolocation and when the remote computing device 110 reports the coordinates outside the geolocation, the resource server 130 may initiate 2FA and/or other authentication procedures. In another aspect, the coordinates may be compared to the previous coordinates. When the distance between the current coordinates and the previous coordinates exceeds a threshold, the resource server 130 may initiate 2FA and/or other authentication procedures.

In another example, the enabled module may include enabling a network location tracking module. The network location tracking module may provide a network location, such as an IP address. The network location may be provided to the resource server 130 to assist in fraud detection. For example, the remote computing device 110 may be restricted to network location and when the remote computing device 110 reports a different network location, the resource server 130 may initiate 2FA and/or other authentication procedures. In another aspect, the network location may be compared to the previous network location. When the network portion of the IP address is different between the current network location and the previous network location, the resource server 130 may initiate 2FA and/or other authentication procedures.

In yet another example, the enabled module may include enabling a biometric sensor, such as a fingerprint sensor. The resource management application 412 may require a biometric verification to unlock a user interface of the resource management application 412. In a similar example, the enablement of modules may include enabling a Personal Identification Number (PIN) interface whereby the entity may enter a PIN. In some aspects, the PIN may be compared to a stored PIN within a payment card.

In even yet another example, the enabled module may include an SMS retriever module configured to capture a one-time code sent to the remote computing device 110 from the resource server 130.

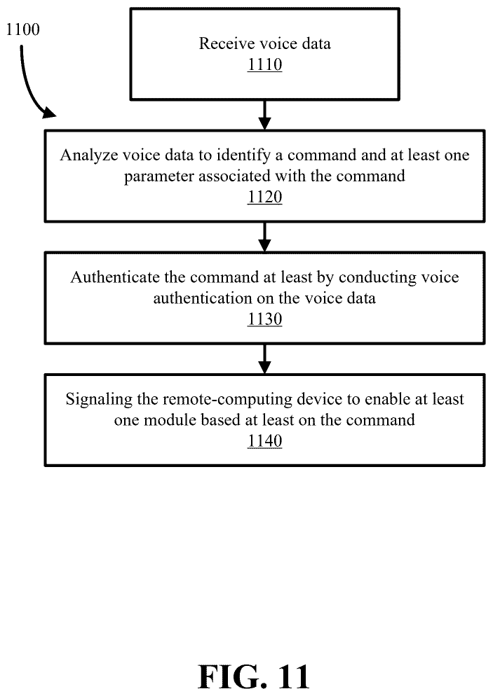

Turning to FIG. 11, a computer-implemented method 1100 is provided. The computer-implemented method may receive voice data (step 1110). The resource server 130 receives voice data in manners as described herein. For example, an entity may speak into their remote computing device 110 and the voice data may be streamed or captured and sent by the remote computing device 110 to the resource server 130.

At step 1120, the voice data may be analyzed to identify a command and at least one parameter in manners as described herein. For example, the voice data may be transformed into one or more embeddings and compared to command embeddings to identify the command. Similarly, the one or more embeddings and compared to parameter embeddings to identify the parameters. In these aspects, the command may include depositing a value instrument and the parameter may include an account type.

At step 1130, the command may be authenticated at least by conducting voice authentication on the voice data in manners as described herein. An audio processor may extract one or more features from the voice data and provide those extracted features to an authentication model 612 to generate a voiceprint. The voiceprint may be compared to a database of voiceprints to identify a match, such as by a similarity score exceeding a threshold.

At step 1140, responsive to successfully authenticating the command, signaling the remote computing device via the communications module to enable at least one module on the remote computing device based at least on the command in manners as described herein. For example, the resource server 130 may transmit a signal to cause the remote computing device 110 to enable one or more modules, such as an image capture module. The enablement of the module may be indicated on a selectable element of the remote computing device 110 and activating the selectable element activates the module. For instance, activating the selectable element causes the image capture module to capture image data. In this manner, the capture of image data of a value instrument may be prevented until such time as the command is authenticated.

The methods herein may be implemented by a computing device having suitable processor-executable instructions for causing the computing device to carry out the described operations. The methods may be implemented, in whole or in part, by the processor 200 of the remote computing device 110. In one or more aspects, the processor 200 may offload some of the operations to the central counterparty server 120, the resource server 130, and/or the parallel computing structure 502.

The resource server 130 may determine that the image data is not acceptable or not of sufficient quality or may determine that transmission of the image data has not been successful. In response, the resource server 130 may send a signal that includes an indication of rejection of the image data to the remote computing device 110.

In one or more aspects, the remote computing device 110 may not receive a signal from the resource server 130. For example, the remote computing device 110 may wait for a signal from the resource server 130 for a predefined amount of time such as for example five (5) seconds, ten (10) seconds, thirty seconds (30), etc. If no signal has been received from the resource server 130 within the predefined amount of time, the remote computing device 110 may determine that sending the signal that includes the image data has timed out.

The above embodiments may be implemented in hardware, in a computer program executed by a processor, in firmware, or in a combination of the above. A computer program may be embodied on a computer readable medium, such as a storage medium. For example, a computer program may reside in random access memory (“RAM”), flash memory, read-only memory (“ROM”), erasable programmable read-only memory (“EPROM”), electrically erasable programmable read-only memory (“EEPROM”), registers, hard disk, a removable disk, a compact disk read-only memory (“CD-ROM”), or any other form of storage medium known in the art.

A storage medium may be coupled to the processor such that the processor may read information from, and write information to, the storage medium. In the alternative, the storage medium and the processor may share the same die. The processor and the storage medium may reside in an application specific integrated circuit (“ASIC”). In the alternative, the processor and the storage medium may reside as discrete components.

The aspects herein may execute on a cloud computing platform with on-demand availability of computer system resources, including data storage, and computing power, with automated active management. Clouds are often distributed, with data centers in multiple locations for availability and performance. Computing resources on clouds are shared across multiple tenants through virtual computing environments comprising virtual machines, databases, containers, and other resources. A container is an isolated, lightweight software for running an application on the host operating system. Containers are built on top of the host operating system's kernel and contain applications and some lightweight operating system APIs and services. Virtual machines are a software layer which include a complete operating system and kernel. Virtual machines are built on top of a hypervisor emulation layer designed to abstract a host computer's hardware from the operating software environment. Clouds generally offer hosted databases abstracting high-level database management activities.

Although an aspect of at least one of a system, method, and computer readable medium has been illustrated in the accompanying drawings and described in the foregoing detailed description, it will be understood that the application is not limited to the embodiments disclosed but is capable of numerous rearrangements, modifications, and substitutions as set forth and defined by the following claims. For example, the system's capabilities of the various figures can be performed by one or more of the modules or components described herein or in a distributed architecture and may include a transmitter, receiver, or pair of both. For example, all or part of the functionality performed by the individual modules may be performed by one or more of these modules. Further, the functionality described herein may be performed at various times and in relation to various events, internal or external to the modules or components. Also, the information sent between various modules can be sent between the modules via at least one of: a data network, the Internet, a voice network, an Internet Protocol network, a wireless device, a wired device and/or via a plurality of protocols. Also, the messages sent or received by any of the modules may be sent or received directly and/or via one or more of the other modules.

One skilled in the art will appreciate that the remote computing device 110 may be embodied as a personal computer, a server, a console, a personal digital assistant (PDA), a cell phone, a tablet computing device, a smartphone, or any other suitable computing device, or combination of devices. The presentation of the above-described functions as being performed by the remote computing device 110 and/or resource server 130 is not intended to limit the scope of the present application but rather to provide one example among many possible embodiments. Indeed, the methods, systems, and apparatuses disclosed herein may be implemented in both localized and distributed forms, consistent with computing technology.

Some of the system features described in this specification have been presented as modules to more particularly emphasize their implementation independence. For example, a module may be implemented as a hardware circuit comprising custom very-large-scale integration (VLSI) circuits or gate arrays, off-the-shelf semiconductors such as logic chips, transistors, or other discrete components. A module may also be implemented in programmable hardware devices such as field programmable gate arrays, programmable array logic, programmable logic devices, graphics processing units, or the like.

A module may also be at least partially implemented in software for execution by various types of processors. An identified unit of executable code may, for instance, comprise one or more physical or logical blocks of computer instructions that may, for instance, be organized as an object, procedure, or function. The executables of an identified module may not be physically located together but may comprise disparate instructions stored in different locations which, when joined logically together, comprise the module and achieve the stated purpose for the module. Further, modules may be stored on a computer-readable medium, which may be, for instance, a hard disk drive, flash device, random access memory (RAM), tape, or any other such medium used to store data.

Indeed, a module of executable code may be a single instruction or many instructions and may even be distributed over several different code segments, among different programs, and across several memory devices. Similarly, operational data may be identified and illustrated herein within modules and may be embodied in any suitable form and organized within any suitable type of data structure. The operational data may be collected as a single data set or may be distributed over different locations, including over different storage devices, and may exist, at least partially, merely as electronic signals on a system or network.

It will be readily understood that the components of the application, as generally described and illustrated in the figures herein, may be arranged and designed in a wide variety of different configurations. Thus, the detailed description of the embodiments is not intended to limit the scope of the application as claimed but is merely representative of selected embodiments of the application.

One having ordinary skill in the art will readily understand that the above may be practiced with steps in a different order and/or with hardware elements in configurations that are different from those which are disclosed. Therefore, although the application has been described based upon these aspects, it would be apparent to those of skill in the art that modifications, variations, and alternative constructions would be apparent.

While aspects of the present application have been described, it is to be understood that the aspects described are illustrative, and the scope of the application is to be defined solely by the appended claims when considered with a full range of equivalents and modifications (e.g., protocols, hardware devices, software platforms, etc.) thereto.

The various embodiments presented above are merely examples and do not limit the scope of this application. Variations of the innovations described herein will be apparent to persons of ordinary skill in the art, such variations being within the intended scope of the present application. Features from one or more of the above-described example embodiments may be selected to create alternative example embodiments including a sub-combination of features which may not be explicitly described above. In addition, features from one or more of the above-described example embodiments may be selected and combined to create alternative example embodiments including a combination of features which may not be explicitly described above. Features suitable for such combinations and sub-combinations would be readily apparent to persons skilled in the art upon review of the present application in its entirety. The subject matter described herein and in the recited claims intends to cover and embrace any changes in technology.

What is claimed is:

1. A server comprising:
a communications module;
at least one processor coupled to the communications module; and
a memory coupled to the at least one processor, the memory storing a plurality of processor-executable instructions which, when executed, configure the at least one processor to:
receive, from a remote computing device and via the communications module, voice data;
analyze the voice data to identify a command and at least one parameter associated with the command;
authenticate the command at least by conducting voice authentication on the voice data; and
responsive to successfully authenticating the command, signaling the remote computing device via the communications module to enable at least one module on the remote computing device based at least on the command.

2. The server of claim 1, wherein when conducting the voice authentication on the voice data, the processor-executable instructions, when executed, further configure the at least one processor to:
extract at least one feature from the voice data to produce a current voiceprint;
retrieve a voiceprint from a voiceprint database;
generate a similarity score between the current voiceprint and the voiceprint; and
determine that the similarity score is above a threshold to complete the voice authentication.

3. The server of claim 2, wherein when generating the similarity score, the processor-executable instructions, when executed, further configure the at least one processor to:
engage an artificial intelligence engine to generate the similarity score based at least on the voice data and the current voiceprint.

4. The server of claim 2, wherein the processor-executable instructions further configure the processor to:
determine that the similarity score is below the threshold; and
in response to the determining that the similarity score is below the threshold, initiate an alternative authentication method.

5. The server of claim 1, wherein when analyzing the voice data, the processor-executable instructions, when executed, further configure the at least one processor to:
engage an artificial intelligence engine transforming the voice data into at least one embedding;
compare the at least one embedding with a plurality of command embeddings to identify the command; and
compare the at least one embedding with a plurality of parameter embeddings to identify the at least one parameter.

6. The server of claim 1, wherein when enabling the at least one module on the remote computing device, the processor-executable instructions, when executed, further configure the at least one processor to:
cause the remote computing device to indicate by way of a selectable element that the at least one module is enabled.

7. The server of claim 1, wherein when enabling the at least one module of the remote computing device, the processor-executable instructions, when executed, further configure the at least one processor to:
cause the remote computing device to execute an image capture module to capture image data.

8. The server of claim 7, wherein the processor-executable instructions, when executed, further configure the at least one processor to:
receive, via the communications module and from the remote computing device, the image data; and
initiate a data transfer at least based on analyzing the image data.

9. The server of claim 1, wherein when signalling the remote computing device, the processor-executable instructions, when executed, further configure the at least one processor to:
send a push notification to the remote computing device with a payload causing the at least one module to be enabled.

10. The server of claim 1, wherein when signalling the remote computing device, the processor-executable instructions, when executed, further configure the at least one processor to:
send an application programming interface request to the remote computing device to cause the at least one module to be enabled.

11. A computer-implemented method comprising:
receiving, from a remote computing device and via a communications module, voice data;
analyzing the voice data to identify a command and at least one parameter associated with the command;
authenticating the command at least by conducting voice authentication on the voice data; and
responsive to successfully authenticating the command, signaling the remote computing device via the communications module to enable at least one module on the remote computing device.

12. The computer-implemented method of claim 11, wherein the voice authentication comprising:
extracting at least one feature from the voice data to produce a current voiceprint;
retrieving a voiceprint from a voiceprint database;
generating a similarity score between the current voiceprint and the voiceprint; and
determining that the similarity score is above a threshold to complete the voice authentication.

13. The computer-implemented method of claim 12, wherein the generating the similarity score comprises:
engaging an artificial intelligence engine to generate the similarity score based at least one the voice data and the current voiceprint.

14. The computer-implemented method of claim 12, further comprising:
determining that the similarity score is below the threshold; and
responsive to the determining that the similarity score is below the threshold, initiating an alternative authentication method.

15. The computer-implemented method of claim 11, wherein when analyzing the voice data, further comprising:
engaging an artificial intelligence engine transforming the voice data into at least one embedding;
comparing the at least one embedding with a plurality of command embeddings to identify the command; and
comparing the at least one embedding with a plurality of parameter embeddings to identify the at least one parameter.

16. The computer-implemented method of claim 11, when enabling the at least one module on the remote computing device, further comprising:
causing the remote computing device to indicate on a selectable element that the at least one module is enabled.

17. The computer-implemented method of claim 11, when enabling the at least one module of the remote computing device, further comprising:
causing the remote computing device to execute an image capture module to capture image data.

18. The computer-implemented method of claim 17, further comprising:
receiving, via the communications module and from the remote computing device, the image data; and
initiating a data transfer at least based on analyzing the image data.

19. The computer-implemented method of claim 11, wherein when signalling the remote computing device, further comprising at least one of:
sending a push notification to the remote computing device with a payload causing the at least one module to be enabled; and
sending an application programming interface request to the remote computing device to cause the at least one module to be enabled.

20. A non-transitory computer readable storage medium comprising processor-executable instructions which, when executed, configure at least one processor to:
receive, from a remote computing device and via a communications module, voice data;
analyze the voice data to identify a command and at least one parameter associated with the command;
authenticate the command at least by conducting voice authentication on the voice data; and
responsive to successfully authenticating the command, signaling the remote computing device via the communications module to enable at least one module on the remote computing device.
